(19) United States
(12) Patent Application Publication
(10) Pub. No.: US 2024/0184541 A1
(43) Pub. Date: Jun. 6, 2024

(54) Method and Apparatus for Executing Workflow Task Across Control Objects

(71) Applicant: Siemens Ltd., China, Beijing (CN)

(72) Inventors: Yi Peng Zhu, Nanjing, Jiangsu Province (CN); Jian Qiang Wu, Shanghai (CN)

(73) Assignee: Siemens Ltd., China, Beijing (CN)

(21) Appl. No.: 18/553,002

(22) PCT Filed: Mar. 31, 2021
(86) PCT No.: PCT/CN2021/084678

§ 371 Date: Sep. 28, 2023

(51) Int. Cl. G06F 8/34

(52) U.S. Cl. CPC G06F 8/34

(57) ABSTRACT

Various embodiments include systems and/or methods for executing a workflow task across control objects. An example method includes: receiving, from a programming tool, workflow description data associated with a workflow task executed across at least one control object; extracting, from the workflow description data, a workflow task model associated with the at least one control object; generating, on the basis of the workflow task model, a text-based script for realizing the workflow task; and interpreting and executing the script using a script engine.

### CROSS-REFERENCE TO RELATED APPLICATIONS

This application is a U.S. National Stage Application of International Application No. PCT/CN2021/084678 filed Mar. 31, 2021, which designates the United States of America, the contents of which are hereby incorporated by reference in their entirety.

### TECHNICAL FIELD

The present disclosure relates to automated systems. Various embodiments of the teachings herein include systems and/or methods for executing a workflow task across control objects.

### BACKGROUND

At present, automated system providers generally provide programming tools (engineering tools) to users to arrange workflow tasks for control objects (e.g. robots, etc.), while the programming tools require a specific runtime environment or executor to perform the workflow tasks provided by the programming tools, for example, to control robot movement. Thus, a runtime executor cooperating with the programming tool is needed to interpret the user objective and control the relevant control object.

For example, 4DIAC-RTE (FORTE) provides a small portable C++ implementation of a runtime environment conforming to the IEC 61499 standard, and supports the execution of distributed control programs on small embedded devices. However, such an implementation has the following shortcomings: it cannot define function blocks dynamically, and the runtime executor needs to be re-compiled when a new function is added; a new standard needs to be constructed for openness, resulting in poor openness; a function block error will cause collapse of the execution process, so stability is inadequate; the execution logic cannot be textualized, making version control difficult; execution data cannot be easily visualized; and the programming efficiency is low from the perspective of the user (e.g. engineering and technical personnel) because function blocks are defined by C++.

### SUMMARY

To address the abovementioned problems, the present disclosure described methods and systems for executing workflow tasks across control objects. By providing an interpretable and executable textual description for workflow tasks, the solution can create function blocks dynamically without the need for re-compiling, thus increasing the programming efficiency for the user and providing good version control.

As an example, some embodiments include a method for executing a workflow task across control objects, the method comprising: receiving, from a programming tool, workflow description data associated with a workflow task executed across at least one control object; extracting, from the workflow description data, a workflow task model associated with the at least one control object; generating, on the basis of the workflow task model, a text-based script for realizing the workflow task; and interpreting and executing the script by means of a script engine.

As another example, some embodiments include an apparatus for executing a workflow task across control objects, the apparatus comprising: a communication interface, configured to receive, from a programming tool, workflow description data associated with a workflow task executed across at least one control object; a parser, configured to extract, from the workflow description data, a workflow task model associated with the at least one control object; generating, on the basis of the workflow task model, a text-based script for realizing the workflow task; and interpreting and executing the script by means of a script engine.

As another example, some embodiments include a system for executing a workflow task across control objects is provided, comprising: a programming tool; and multiple apparatuses as described in the present disclosure.

As another example, some embodiments include a computing device comprising: at least one processor; and a memory coupled to the at least one processor and used to store an instruction; when the instruction is executed by the at least one processor, the at least one processor is caused to execute one or more of the methods as described in the present disclosure.

As another example, some embodiments include a non-transitory machine-readable storage medium, having stored thereon an executable instruction which, when executed, causes a machine to execute one or more of the methods as described in the present disclosure.

As another example, some embodiments include a computer program, comprising a computer-executable instruction which, when executed, causes at least one processor to execute one or more of the methods as described in the present disclosure.

As another example, some embodiments include a computer program product tangibly stored on a computer-readable storage medium and comprising a computer-executable instruction which, when executed, causes at least one processor to execute one or more of the methods as described in the present disclosure.

### BRIEF DESCRIPTION OF THE DRAWINGS

The features, advantages and other aspects of embodiments of the present disclosure will become more obvious with reference to the drawings and the detailed description below. Embodiments of the present disclosure are shown here in an exemplary but non-limiting manner. In the drawings:

FIG. 1 shows an exemplary system in which a workflow task may be executed across control objects incorporating teachings of the present disclosure;

FIG. 2 shows an exemplary apparatus for executing a workflow task across control objects, which is included in the system in FIG. 1;

FIG. 3 shows a flow chart of an exemplary method of a method for executing a workflow task across control objects incorporating teachings of the present disclosure;

FIG. 4 shows an illustration of an exemplary workflow task incorporating teachings of the present disclosure;

FIG. 5 shows an exemplary text-based script incorporating teachings of the present disclosure; and

FIG. 6 shows a block diagram of an exemplary computing device for executing a workflow task across control objects incorporating teachings of the present disclosure.

### DETAILED DESCRIPTION

Exemplary embodiments of the present disclosure are described in detail below with reference to the drawings. Although the exemplary methods and apparatuses described below include software and/or firmware executed on hardware in other components, it should be noted that these examples are merely illustrative and should not be regarded as limiting. For example, it is considered that any or all hardware, software and firmware components may be implemented in hardware exclusively, in software exclusively, or in any combination of hardware and software. Thus, although exemplary methods and apparatuses have already been described below, those skilled in the art will easily understand that the examples provided are not intended to limit the way in which these methods and apparatuses are implemented.

Furthermore, the flow charts and block diagrams in the drawings show possible system architectures, functions and operations of the method and system according to embodiments of the present disclosure. It should be noted that the functions marked in the boxes may also take place in a different order from that marked in the drawings. For example, two boxes shown consecutively may in fact be executed essentially in parallel, or sometimes may also be executed in reverse order, depending on the functions concerned. It should also be noted that each box in the flow charts and/or block diagrams, and combinations of boxes in the flow charts and/or block diagrams, may be implemented using a dedicated hardware-based system that executes specified functions or operations, or may be implemented using a combination of dedicated hardware and computer instructions.

The terms “comprises”, “includes” and similar terms used herein are open terms, e.g. “comprises/includes but is not limited to”, meaning that other content may also be included. The term “based on” is “at least partly based on”. The term “an embodiment” means “at least one embodiment”; and the term “another embodiment” means “at least one other embodiment”, and so on.

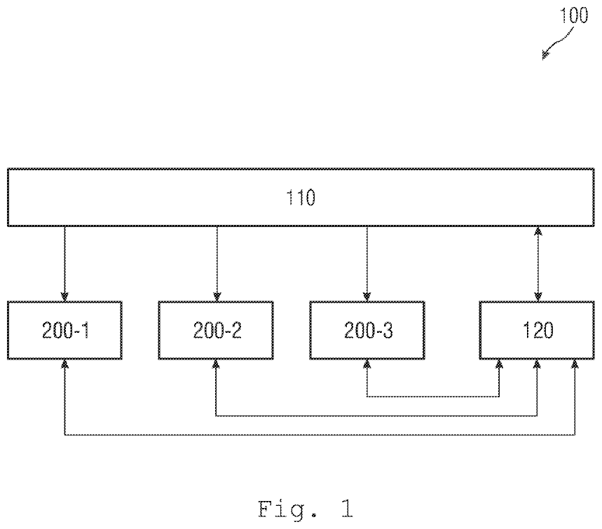

FIG. 1 shows an exemplary system 100 in which a workflow task may be executed across control objects. The exemplary system 100 comprises a programming tool 110, middleware 120, and multiple runtime executors 200-1, 200-2, 200-3. The programming tool 110 running on, for example, an engineering station host may write a workflow task for execution across at least one control object by means of an interactive human-machine interface (HMI) for example, generate workflow description data according to the workflow task, and then send the workflow description data to the runtime executors 200-1, 200-2, 200-3 via a wireless or wired connection for example. The runtime executors 200-1, 200-2, 200-3 may convert the received workflow description data to a script which is based on textual description and executable by a script engine (e.g. Python, CPython, Nodejs engines, etc.) and execute the script, in order to realize the workflow task. The different runtime executors 200-1, 200-2, 200-3 may be implemented in the form of software or hardware, and run on the same device (e.g. distinguished by different ports) or run on different devices.

The middleware 120 may communicate with the programming tool 110 and the runtime executors 200-1, 200-2, 200-3, to realize control scheduling and data transmission thereamong, so the middleware 120 serves as a data bus between the programming tool 110 and the runtime executors, and between the runtime executors.

It should be understood that the quantities of programming tool (s), middleware and runtime executor (s) in FIG. 1 are merely examples; in other examples, the quantities of programming tool (s), middleware and runtime executor (s) may be other suitable quantities. For example, the runtime executors may receive workflow task description data conforming to a standard format (e.g. IEC 61499 or another possible future open standard, etc.) from multiple programming tools of different types, and covert this data to an executable script.

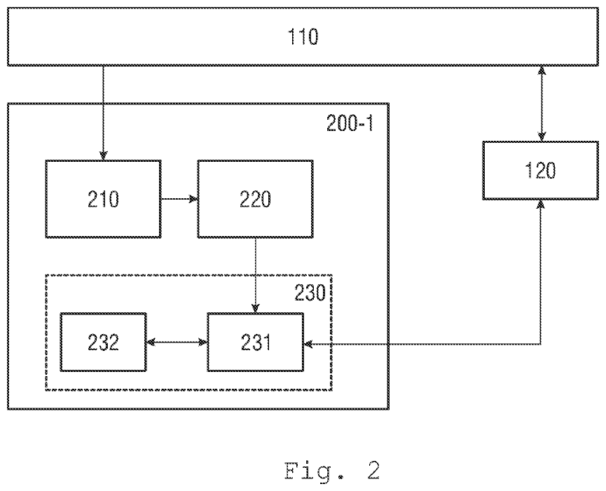

FIG. 2 shows an exemplary apparatus 200-1 for executing a workflow task across control objects, which is included in the system 100 in FIG. 1. The exemplary apparatus 200-1 comprises a communication interface (not shown), a parser 210, a script generator 220 and a script engine module 230. The communication interface of the exemplary apparatus 200-1 is configured to receive, from the programming tool 110, workflow description data associated with a workflow task executed across at least one control object, and provide the workflow description data to the parser 210. The parser 220 is configured to extract, from the workflow description data, a workflow task model associated with the at least one control object. The script generator 220 is configured to generate, on the basis of the workflow task model, a text-based script for realizing the workflow task, and provide the script to the script engine module 230. The script engine module 230 is configured to interpret and execute the generated script.

In some embodiments, the apparatus 200-1 may communicate with the programming tool 110 via the middleware 120 to realize monitoring and control of an execution process of the workflow task, and this may comprise at least one of the following: the script engine module 230 being configured to map, to the middleware 120, state data and process data relating to the execution process, so that the programming tool 110 can acquire the state data and process data; the script engine module 230 being configured to receive control information relating to the execution process from the programming tool 110 via the middleware 120. Communicative interaction between the apparatus 200-1 and the programming tool 110 is provided by means of the middleware 120; system decoupling can be realized, and the arrangement is suitable for a distributed control system, and the middleware can be changed flexibly according to performance needs—for example, the middleware may be realized as a real-time data bus (e.g. DDS) to ensure real-time data transmission. For example, the script engine module 230 may publish, to the middleware 120, state data and process data to which the programming tool 110 subscribes (e.g. state data of function blocks, control objects and execution processes (e.g. run, stop, execute to which point in the process, execution time, etc.) and process data (e.g. data generated by function blocks and control objects during execution, etc.)), based on a publish-subscribe relationship or information. For example, the script engine module 230 is configured to receive control information relating to the execution process from the programming tool 110 via the middleware 120, to control the execution of the process (e.g. at which point and what time to stop or continue execution, restart, abnormal processing, etc.); for example, based on state data and process data acquired from the script engine 230 of the runtime executor 200-1 via the middleware 120, the programming tool 110 may generate control information to reverse-control the execution of the process. Because the programming tool 110 can exchange data with the runtime executor conveniently via the middleware 120, the acquired state and process data can be easily displayed in the HMI; thus, compared with existing implementations such as FORTE, there is no need to additionally write data communication with the C++ language, and the problems of difficulty of data visualization and low programming efficiency are solved.

In some embodiments, the workflow task model describes multiple function blocks associated with at least one control object, and a connection relationship between the multiple function blocks. For example, the parser 210 may parse function blocks (nodes) and a connection relationship between the function blocks from the workflow description data; each function block may be associated with a specific runtime executor and control object, and the connection relationship between the function blocks may indicate a collaborative relationship between the runtime executors. The function blocks described by means of the workflow task model may have, for example, inputs/outputs and function logic (e.g. events, etc.).

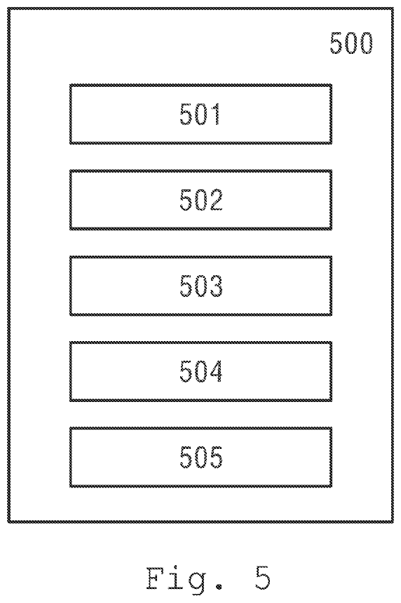

In some embodiments, the script may comprise: a textual description of an n imported function block, a textual description of an overloaded function block, a textual description of function block parameter settings, and a textual description of event scheduling. Details of the textualized script are described in detail below with reference to FIG. 5.

In some embodiments, the script engine module 230 may be configured to instantiate, on a virtual machine 230, a function block associated with at least one control object and execute the function block. For example, the script engine module 230 may be a high-level language engine such as Python, CPython or Nodejs, and instantiates the function block by calling, on the virtual machine 230, a module (which may be an existing one or provided by the automation system provider) corresponding to the control object. In addition, the script engine module 230 may instantiate the function block by calling and/or downloading, on the virtual machine 230, a module (which may be provided by a third party) from an engine's community library and ecosystem, thereby greatly reducing the difficulty of user development. For example, if the user wishes to add to a workflow task a module (e.g. a modbus module) for controlling a PLC, but is not familiar with the module, he may self-define a function to directly download the modbus module provided by the community library and ecosystem and import same into the runtime executor to realize the relevant business logic. Using various mature script engines and their built-in virtual machine mechanisms and ecosystems, execution process collapse caused by function block or module errors can be avoided, and openness is good, so compared with existing implementations such as FORTE, the problems of poor openness and inadequate stability can be solved.

In some embodiments, the at least one control object comprises a first control object and a second control object operated in cooperation; moreover, the script engine module 230 is a first script engine module on a first runtime executor 200-1 and is configured to execute a script associated with the first control object, and a script associated with the second control object is executed by means of a second script engine module on a second runtime executor (e.g. 200-2 or 200-3); control object scheduling between the first runtime executor 200-1 and second runtime executor (e.g. or 200-3) is realized by means of the middleware 120. In an existing implementation such as FORTE, cooperative scheduling between multiple runtime executors must be realized by explicitly adding a protocol communication module (e.g. a socket communication module, such as paired socket publish and subscribe modules, etc.); in comparison, the present disclosure avoids the need to explicitly add a protocol communication module by providing middleware, so that the user does not need to be concerned about how protocol communication between runtime executors is realized.

In some embodiments, the workflow description data is generated according to the IEC 61499 standard. The IEC 61499 standard is a standard published by the International Electrotechnical Commission for distributed industrial process measurement and control systems (IPMCS). Interoperability between different manufacturers' devices may be resolved by providing a data format that rigorously conforms to the IEC standard. In other examples, the workflow description data may conform to a standard format, e.g. a data format of various existing open standards or possible future open standards, etc.

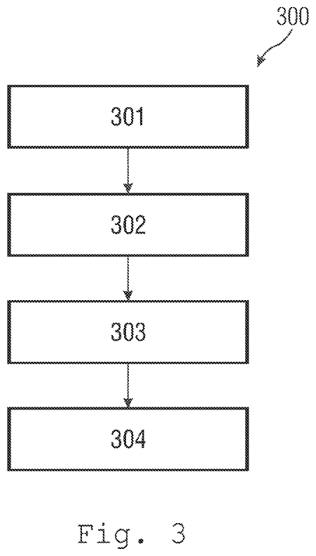

FIG. 3 shows a flow chart of an exemplary method 300 of a method for executing a workflow task across control objects incorporating teachings of the present disclosure. The method 300 may be realized by any runtime executor 200-1, 200-2 or 200-3, for example those in FIG. 1 or FIG. 2.

As shown in FIG. 3, the method 300 starts at step 301. In step 301, workflow description data associated with a workflow task executed across at least one control object is received from a programming tool. For example, step 301 may be performed by the communication interface of the apparatus 200-1 as shown in FIG. 2.

In some embodiments, the workflow description data is generated according to the IEC 61499 standard.

Next, the method 300 proceeds to step 302. In step 302, a workflow task model associated with at least one control object is extracted from the workflow description data. For example, step 302 may be performed by the parser 210 of the apparatus 200-1 as shown in FIG. 2.

In some embodiments, the workflow task model describes multiple function blocks associated with at least one control object, and a connection relationship between the multiple function blocks.

Next, the method 300 proceeds to step 303. In step 303, based on the workflow task model, a text-based script for realizing the workflow task is generated. For example, step 303 may be performed by the script generator 220 of the apparatus 200-1 as shown in FIG. 2.

In some embodiments, step 303 may comprise: generating a textual description of an imported function block, a textual description of an overloaded function block, a textual description of function block parameter settings, and a textual description of event scheduling.

Next, the method 300 proceeds to step 304. In step 304, the script is interpreted and executed by means of a script engine. For example, step 304 may be performed by the script engine module 230 of the apparatus 200-1 as shown in FIG. 2.

In some embodiments, step 304 may comprise: instantiating, on a virtual machine, a function block associated with at least one control object, and executing the function block.

In some embodiments, the method 300 may further comprise the following step: communicating with the programming tool via middleware to realize visual monitoring and control of an execution process of the workflow task; this may comprise at least one of the following: mapping, to the middleware, state data and process data relating to the execution process by means of the script engine, so that the programming tool acquires the state data and process data; receiving control information relating to the execution process from the programming tool via the middleware by means of the script engine. For example, this step may be performed by the script engine module 230 of the apparatus 200-1 as shown in FIG. 2.

In some embodiments, the at least one control object may comprise a first control object and a second control object operated in cooperation, and the step of interpreting and executing the script by means of the script engine may comprise: executing a script associated with the first control object by means of a first script engine on a first runtime executor, and executing a script associated with the second control object by means of a second script engine on a second runtime executor; and the method 300 may further comprise: realizing, by means of middleware, control object scheduling between the first runtime executor and the second runtime executor.

The apparatus and method for executing a workflow task across control objects as described in accordance with FIGS. 2 and 3 may allow the following: by providing an interpretable and executable text-based script for a workflow task, function blocks can be dynamically created without the need for re-compiling, so user programming efficiency is improved and good version control is provided; by providing middleware to better support data exchange, data visualization can be easily realized and programming efficiency can be easily improved; and by providing a mature script engine and its built-in virtual machine mechanism and ecosystem, good openness and stability can be provided.

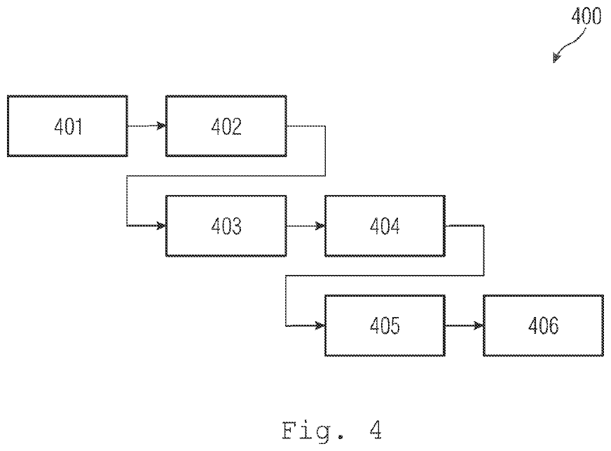

FIG. 4 shows an illustration of an exemplary workflow task 400 incorporating teachings of the present disclosure. As shown in FIG. 4, using a programming tool (e.g. the programming tool 110), in one scenario the user can realize system configuration of a robot arm and gripper by dragging and dropping multiple function blocks 401, 402, 403, 404, 405, 406. Function blocks 401 and 406 respectively represent “Start” and “Done” of the workflow task 400, function blocks 402 and 404 are executed by a runtime executor (e.g. Runtime1) associated with the robot arm and respectively represent Robot_Init and Robot Move, and function blocks 403 and 405 are executed by a runtime executor (e.g. Runtime2) associated with the gripper and respectively represent Gripper Init and Gripper Move. The connections between the multiple function blocks 401-406 represent the cooperative relationships therebetween; for example, the output of function block 401 is “done”, the input of function block 406 is “done”, and each of the function blocks 402-405 has “start” as input and “done” as output. That is to say, the function blocks 401-406 and their connections show the cooperation of the robot arm and gripper to realize a process of positioning an object for example, and the robot arm and gripper need to be operated in cooperation. As stated above, cooperative scheduling between different runtime executors may be realized by means of middleware. The parser of the runtime executor may extract a workflow task model from workflow description data relating to the workflow task, wherein the workflow task model describes multiple function blocks associated with at least one control object (e.g. the robot arm or gripper) and a connection relationship between the multiple function blocks. For example, the workflow task 400 may be parsed by means of nodes and links; the function block relating to Robot_Init is converted to a function block node, and the connecting line between function blocks 401 and 402 will be converted to a link having a starting point (Start.done) and an end point (Robot_Init.start).

FIG. 5 shows an exemplary text-based script 500 incorporating teachings of the present disclosure. For example, the script 500 may be generated by the script generator 220 of the apparatus 200-1 shown in FIG. 2. The script 500 may comprise a textual description 501 of an imported function block, a textual description 502 of an overloaded function block, a textual description 503 of function block parameter settings, a textual description 504 of event scheduling, and an optional other textual description 505 (e.g. thread security, process control, etc.).

The pseudocode below provides an example of a textual description 501 of an imported function block:

```
  LOAD BUS
  DEF CLASS FB:
  PRIVATE:
    NAME:STRING
    STATIC_DESCRIPTION_=
{“IN_EVENT”:[ ],”OUT_EVENT”:[ ],”DATA_IN”:[
],”DATA_OUT”:[ ]}
    CONSTRUCTOR(NAME):
      SELF.NAME ← NAME;
      For EVENT IN DESCRIPTION:
        BUS.SUBSCRIBE(EVENT)
  PUBLIC
    DEF INPUT_IN1:
      CALL OUTPUT_OUT1
    DEF INTPUT_IN2:
      CALL OUTPUT_OUT2
    DEF GET_PORT_TYPE(PORTNAME):
      RETURN PORT_TYPE
  END_DEF CLASS
```

The pseudocode below provides an example of a textual description 502 of an overloaded function block, e.g. the output realization of an overloaded function block:

```
Load FB;
CLASS FB_IMPLEMENT:FB
DEF OUTPUT_OUT1:
  BUS.publish(SELF.NAME, OUT1);
DEF OUTPUT_OUTPUT2:
  BUS.publish(SELF.NAME, OUT2);
```

The pseudocode below provides an example of a textual description 503 of function block parameter settings, e.g. a bus setting default parameter values of a function block:

```
  FOR FB_INSTANCE IN FB_NODE_LIST
    INSTANCE_LIST[{FB_INSTANCE.NAME}]
FB_IMPLEMENT_CLASS({FB_INSTANCE_NAME})
  END_FOR
  BUS ← BUS.SET({FB_INSTANCE}.{FB.PORT},
  “DEFAULT_VALUE”);
```

The pseudocode below provides an example of a textual description 504 of event scheduling, e.g. bus event scheduling:

```
DEF RUN:
  REGISER_SYSQUIT
  BUS.PUBLISH_START
  FOR SIGNAL IN BUS.TOPIC:
    IF SIGNAL IS MATCHED INPUT_EVENT:
      CALL CURRENT_FB.EVENT_METHOD( )
    IF SIGNAL IS MATCHED OUTPUT_EVENT:
    BUS.PUBLIS(NEXT_FB.INEVNT)
```

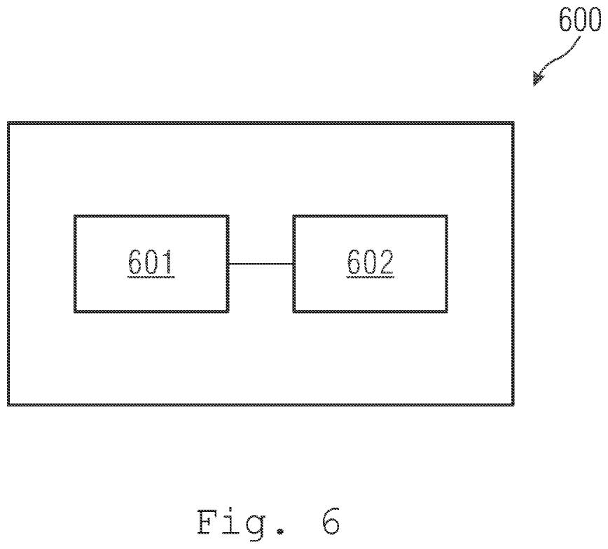

In some embodiments, the apparatuses 200-1, 200-2, 200-3 for executing a workflow task across control objects may be realized by a computing device. FIG. 6 shows a block diagram of an exemplary computing device 600 for executing a workflow task across control objects incorporating teachings of the present disclosure. In some embodiments, the computing device 600 may comprise a processor 601, wherein the processor 601 executes at least one computer-readable instruction stored or encoded in a computer-readable storage medium (i.e. a memory 602).

In some embodiments, a computer-executable instruction is stored in a memory 602, and when the computer-executable instruction is executed, at least one processor 601 is caused to: receive, from a programming tool, workflow description data associated with a workflow task executed across at least one control object; extract, from the workflow description data, a workflow task model associated with the at least one control object; based on the workflow task model, generate a text-based script for realizing the workflow task; and interpret and execute the script by means of a script engine.

The computer-executable instruction stored in the memory 602, when executed, causes at least one processor 601 to perform various operations and functions of the method and apparatus described above.

In some embodiments, a non-transitory machine-readable medium may have a machine-executable instruction which, when executed by a machine, causes the machine to perform various operations and functions of the method and apparatus described above.

In some embodiments, a computer program comprises a computer-executable instruction which, when executed causes at least one processor to perform various operations and functions of the method and apparatus described above.

In some embodiments, a computer program product comprises a computer-executable instruction which, when executed, causes at least one processor to perform various operations and functions of the method and apparatus described above.

In general, the embodiments of the present disclosure may be implemented in hardware or dedicated circuitry, software, firmware, logic, or any combination thereof. Some aspects may be implemented in hardware, while other aspects may be implemented in firmware or software executable by a controller, microprocessor or other computing device. When aspects of embodiments of the present disclosure are illustrated or described as block diagrams/flow charts or represented using other graphic forms, it will be understood that the boxes, apparatuses, systems, techniques or methods described here may be implemented as non-limiting examples in hardware, software, firmware, dedicated circuitry or logic, general-purpose hardware or controllers or other computing devices, or combinations thereof.

A computer-readable program instruction or computer program product used to execute teachings of the present disclosure may also be stored in the Cloud; when it needs to be called, the computer-readable program instruction stored in the Cloud and used to execute an embodiment of the present disclosure can be accessed by a user via mobile internet, a fixed network or another network, so as to implement the technical solution disclosed in the present disclosure.

The particular implementations expounded above with reference to the drawings describe exemplary embodiments, but do not represent all embodiments that can be realized or fall within the scope of protection of the claims. The terms “exemplary” used throughout this Description means “used as an example, instance or illustration”, but does not mean “preferred” or “advantageous” compared with another embodiment. With the aim of providing understanding of the techniques described, particular implementations include specific details. However, these techniques may be implemented without these specific details. In some instances, to avoid making the concepts of the described embodiments difficult to understand, well known structures and apparatuses are shown in the form of block diagrams.

The above description of the content of the present disclosure is provided to enable any person skilled in the art to realize or use the content of the present disclosure. To a person skilled in the art, various amendments to the content of the present disclosure are obvious, and the general principles defined herein may be applied to other variants without departing from the scope of protection of the content of the present disclosure. Thus, the content of the present disclosure is not limited to the examples and designs described herein, but is consistent with the broadest scope conforming to the principles and novel features disclosed herein.

What is claimed is:

1. A method for executing a workflow task across control objects, the method comprising:
receiving, from a programming tool, workflow description data associated with a workflow task executed across at least one control object;
extracting, from the workflow description data, a workflow task model associated with the at least one control object;
generating, on the basis of the workflow task model, a text-based script for realizing the workflow task; and
interpreting and executing the script using a script engine.

2. The method as claimed in claim 1, further comprising:
communicating with the programming tool via middleware to realize visual monitoring and control of an execution process of the workflow task, including at least one of:
mapping, to the middleware, state data and process data relating to the execution process by means of the script engine, so that the programming tool acquires the state data and the process data;
receiving control information relating to the execution process from the programming tool via the middleware by means of the script engine.

3. The method as claimed in claim 1, wherein the workflow task model 1 describes multiple function blocks associated with the at least one control object, and a connection relationship between the multiple function blocks.

4. The method as claimed in claim 3, wherein generating, on the basis of the workflow task model, a text-based script for realizing the workflow task, comprises generating a textual description of an imported function block, a textual description of an overloaded function block, a textual description of function block parameter settings, and a textual description of event scheduling.

5. The method as claimed in claim 3, wherein interpreting and executing the script by means of a script engine comprises instantiating, on a virtual machine, a function block associated with the at least one control object, and executing the function block.

6. The method as claimed in claim 1, wherein:
the at least one control object comprises a first control object and a second control object operated in cooperation; and
interpreting and executing the script by means of a script engine comprises: executing a script associated with the first control object by means of a first script engine on a first runtime executor, and executing a script associated with the second control object by means of a second script engine on a second runtime executor; and
the method further comprises realizing, by means of middleware, control object scheduling between the first runtime executor and the second runtime executor.

7. The method as claimed in claim 1, wherein the workflow description data is generated in accordance with IEC 61499 standard.

8. An apparatus for executing a workflow task across control objects, the apparatus comprising:
a communication interface configured to receive, from a programming tool, workflow description data associated with a workflow task executed across at least one control object;
a parser configured to extract, from the workflow description data, a workflow task model associated with the at least one control object;
a script generator configured to generate, on the basis of the workflow task model, a text-based script for realizing the workflow task; and
a script engine module configured to interpret and execute the script.

9. The apparatus as claimed in claim 8, wherein the apparatus communicates with the programming tool via middleware to realize monitoring and control of an execution process of the workflow task, and this comprises at least one of:
the script engine module being configured to map, to the middleware, state data and process data relating to the execution process, so that the programming tool acquires the state data and the process data;
the script engine module being configured to receive control information relating to the execution process from the programming tool via the middleware.

10. The apparatus as claimed in claim 8, wherein the workflow task model describes multiple function blocks associated with the at least one control object, and a connection relationship between the multiple function blocks.

11. The apparatus as claimed in claim 10, wherein the script comprises: a textual description of an imported function block, a textual description of an overloaded function block, a textual description of function block parameter settings, and a textual description of event scheduling.

12. The apparatus as claimed in claim 10, wherein the script engine module is configured to instantiate, on a virtual machine, a function block associated with the at least one control object, and execute the function block.

13. The apparatus as claimed in claim 8, wherein:
the at least one control object comprises a first control object and a second control object operated in cooperation;
the script engine module is a first script engine module on a first runtime executor and is configured to execute a script associated with the first control object, and a script associated with the second control object is executed by means of a second script engine module on a second runtime executor; and
control object scheduling between the first runtime executor and the second runtime executor is realized by means of middleware.

14. The apparatus as claimed in claim 8, wherein the workflow description data is generated in accordance with IEC 61499 standard.

15-19. (canceled)
